(19) United States
(12) Patent Application Publication
(10) Pub. No.: US 2001/0046874 A1
(43) Pub. Date: Nov. 29, 2001

(54) Apparatus for relaying a transmission signal

(76) Inventors: Jong Sun Kim, Kyunggi-do (KR); Seon Ho Sim, Seoul (KR); Joong Kil Kang, Kyunggi-do (KR); Soo Young Lee, Seoul (KR)

Correspondence Address: PENNIE AND EDMONDS, 1155 AVENUE OF THE AMERICAS, NEW YORK, NY, 100362711

(21) Appl. No.: 09/888,465

(22) Filed: Jun. 25, 2001

Related U.S. Application Data
(63) Continuation of application No. PCT/KR00/01203, filed on Oct. 24, 2000.

(30) Foreign Application Priority Data
Oct. 25, 1999 (KR) 1999-46255

(51) Int. Cl. H04B 7/005

(52) U.S. Cl. 455/506; 455/504

(57) ABSTRACT

An apparatus relays a signal transmitted from a specified base station to a mobile station in CDMA wireless telecommunications systems. To this purpose, the apparatus, installed in an area where signals transmitted from a plurality of base stations co-exist or a soft blocking occurs, operates by following the steps of receiving the signal transmitted from a specified base station having smaller number of calls than the other neighboring base stations, filtering a signal within a service frequency band from the received signal, amplifying the filtered signal, adjusting a gain of the amplified signal and finally transmitting the gain-adjusted signal to the mobile station. Accordingly, a pilot pollution phenomenon is removed and an effective call distribution is achieved, so that the efficiency in using system resources can be greatly improved.

### FIELD OF THE INVENTION

The present invention relates to a mobile telecommunications system; and, more particularly, to an apparatus for amplifying a signal transmitted from a specified base station and relaying thus amplified signal to a mobile station.

### BACKGROUND OF THE INVENTION

In CDMA (code division multiple access) mobile telecommunications systems such as personal communications systems, wireless data communications networks, next generation telecommunications systems (IMT-2000), and the like, transmission of signals is performed by using a same frequency at an identical time. Each of the signals, however, uses a different pilot number, thereby having orthogonality. Therefore, a receiving end needs to know the pilot number and should be synchronized before receiving the signal.

In the CDMA telecommunications system, a mobile station (MS) requests an establishment of a call to a base station (BS) transmitting the strongest signal among a plurality of base stations nearby.

As shown in FIG. 1, in a downtown area or in a place where base stations are densely located, a pilot pollution phenomenon, in which signals transmitted from a plurality of base stations co-exist, or an excessive handoff (e.g. 3-way or beyond), in which a single mobile station is simultaneously connected to a multiplicity of base stations, may occur.

As illustrated in FIG. 1, if a mobile station 160 is located in an area covered by four different base stations, the above-stated pilot pollution phenomenon or excessive handoff occurs, and thus a first to a fourth base stations 110 to 140 all allocate their resources to the mobile station 160, so that the efficiency in using system resources is deteriorated.

To be more specific, a signal-to-noise ratio (SNR) must be sustained above a certain level in order to guarantee the quality of signals and communications in the mobile station. However, in the pilot pollution area where the signals transmitted from the plurality of base stations co-exist, since a receiving end (a forward link) of the mobile station recognizes as noises signals transmitted from base stations other than the one the mobile station is currently connected to, the signal-to-noise ratio of the mobile station gets relatively lowered, so that the quality of signals and communications is impaired, resulting in a communications disorder.

Furthermore, in order to improve the quality of signals and communications, the mobile station transmits its signals with an increased transmission (TX) power, which in turn shortens longevity of a battery in the mobile station as well as reduces capacity and coverage of the system, thereby causing some discomfort for a mobile phone user.

As a solution to the above-mentioned drawbacks, a general-purpose repeater or an optical repeater has been installed between the base station and the mobile station so as to amplify and transmit the received signals.

However, in the case of using the general-purpose repeater or optical repeater to amplify the signals, there occurs a problem that the level of noise generated in the signals transmitted from the mobile station to the base station is also amplified.

### SUMMARY OF THE INVENTION

It is, therefore, a primary object of the present invention to provide an apparatus for relaying only the signal transmitted from a specified base station (BS) to a receiving end of a mobile phone when a plurality of BS signals co-exist in a certain area, thereby preventing the reduction of efficiency in the use of system resources that may be caused by a pilot pollution phenomenon or an excessive handoff.

In accordance with the present invention, there is provided an apparatus for relaying a transmission signal, comprising:

a receiving unit for receiving the transmission signal from a specified base station;

a signal processing unit for processing the received signal; and

a transmitting unit for transmitting the processed signal to a mobile station.

### BRIEF DESCRIPTION OF THE DRAWINGS

The above and other objects and features of the present invention will become apparent from the following description of preferred embodiments given in conjunction with the accompanying drawings, in which:

FIG. 1 shows a situation where signals transmitted from a plurality of base stations co-exist;

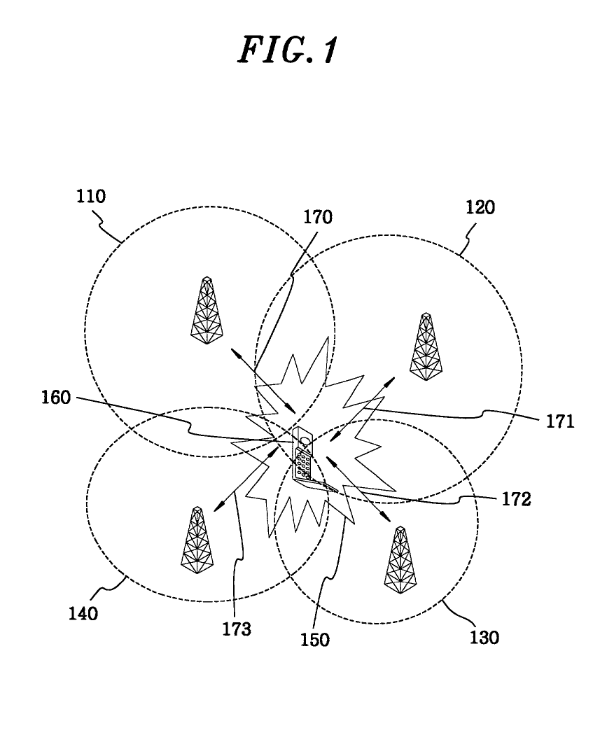

FIG. 2 is a block diagram of an apparatus for relaying a transmission signal in accordance with the present invention; and

FIG. 3 illustrates the apparatus for relaying a transmission signal of the present invention, which is installed in an area where signals transmitted from a plurality of base stations co-exist.

### DETAILED DESCRIPTION OF THE PREFERRED EMBODIMENTS

The preferred embodiments of the present invention will now be explained in detail with reference to the accompanying drawings.

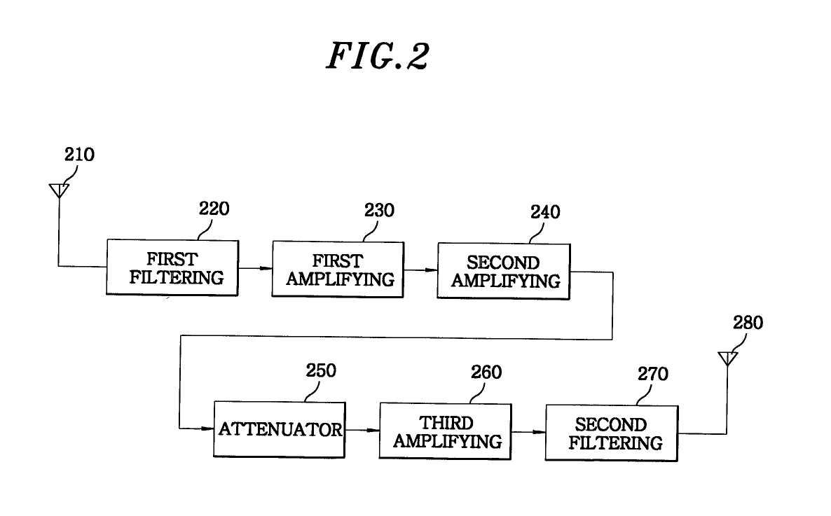

FIG. 2 depicts a block diagram of an apparatus for relaying a transmission signal in a mobile telecommunications system in accordance with the present invention. The relaying apparatus comprises a receiving antenna 210 for receiving a signal transmitted from a specified base station, a signal processing unit for processing the received signal, which includes a first filtering unit 220, a first and a second amplifying unit 230 and 240, an attenuator 250, a third amplifying unit 260, a second filtering unit 270, and a transmitting antenna 280 for transmitting the signal provided from the signal processing unit to a mobile station.

Hereinafter, an operation of the relaying apparatus having the above constitution will be described in detail.

The receiving antenna 210 has a high gain and a narrow horizontal beam width and is structured to receive the signal transmitted from the specified base station. That is, in a pilot pollution area or at a place where a soft blocking occurs to block calls, when the system is overloaded beyond its capacity, in order to maintain a certain level of communications quality, the receiving antenna 210 receives the signal transmitted from the specified base station, wherein the specified base station is, for example, a base station having relatively smaller number of calls than other base stations neighboring to the one in which the soft blocking occurs, and provides the received signal to the first filtering unit 220, i.e., a band-pass filter.

The first filtering unit 220 filters only a desired signal band, i.e., a service frequency band from the transmission signal of the specified base station provided through the receiving antenna 210, and then sends the filtered signal to the first amplifying unit 230.

The first amplifying unit 230 is a low noise amplifier (LNA), and primarily amplifies the signal within the service frequency band provided from the first filtering unit 220. After the first amplification, the signal is re-amplified at the second amplifying unit 240 and then provided to the attenuator 250.

Since the strength of the signal that arrives at the relaying apparatus from the base station varies depending on the environment of the service area, the attenuator 250 properly adjusts the gain of the amplified signal provided from the second amplifying unit 240 and provides the third amplifying unit 260 with the adjusted signal.

The third amplifying unit 260, as a high power amplifier (HPA), lastly amplifies the gain-adjusted signal, and then provides the second filtering unit 270 with the finally amplified signal.

The second filtering unit 270 filters off noises generated while the signal transmitted from the specified base station is processed. Then, the filtered signal is transmitted to the mobile station via the transmitting antenna 280.

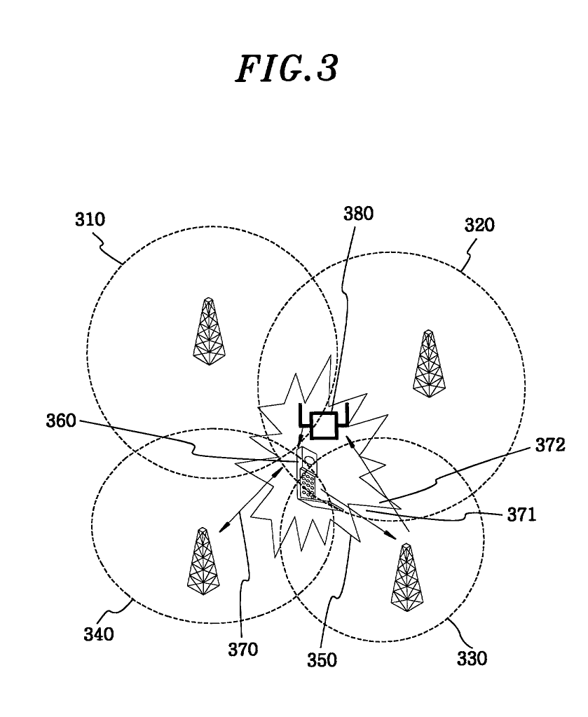

FIG. 3 shows the relaying apparatus operating as described above, which is installed in a pilot pollution area or at a place where the soft blocking occurs.

As can be seen in FIG. 3, if signals transmitted from a plurality of base stations co-exist in a pilot pollution area 350, and thus the soft blocking occurs for a currently serving base station, a relaying apparatus 380 installed in that area selects a base station having comparatively small number of calls among base stations neighboring to the currently serving base station as a specified base station. Then the relaying apparatus 380 transmits only the signal transmitted from the specified base station to a mobile station, so that a signal-to-noise ratio for the specified base station and the communications quality are improved.

To be specific, the relaying apparatus of the present invention monitors the occurrence of the soft blocking in a downtown area or in a place where there exists a plurality of densely located base stations and signals transmitted therefrom. In case the soft blocking occurs, the relaying apparatus searches for the specified base station among the neighboring base stations.

The above process of finding the base station in which the soft blocking occurs and the specified base station having smallest number of calls is carried out by engineers of telecommunications companies, and may be easily understood by those skilled in the art.

For example, in FIG. 3, there is illustrated a place where signals transmitted from a plurality of base stations co-exist, wherein a first base station 310 is found as the base station where the soft blocking occurs and a third base station 330 is selected to have the least calls among the neighboring base stations. When installed in such pilot pollution area, the relaying apparatus 380 transmits only the signals transmitted from the specified base station, i.e., the third base station 330, to a mobile station 360. As a result, the calls are dispersed and the signal-to-noise-ratio for the specified base station is enhanced.

The relaying apparatus 380 also amplifies the strength of the signal transmitted from the specified base station and transmits the amplified signal to the mobile station 360. Accordingly, a rate of system resources wasted by an excessive handoff can be reduced, so that the efficiency in using the system resources can be improved.

As described above, the transmission signal relaying apparatus 380 receives through the receiving antenna 210 only the signal transmitted from the third base station 330 having the least calls among the neighboring base stations; then extracts a signal within the service frequency band from the received signal at the first filtering unit 220; performs the first and second amplification at the first and the second amplifying units 230 and 240; adjusts a gain of the amplified signal at the attenuator 250; lastly amplifies the gain-adjusted signal at the third amplifying unit 260; filters the lastly amplified signal at the second filtering unit 270; and finally transmits the filtered signal through the transmitting antenna 280 to the mobile station 360. By using the inventive relaying apparatus, both the signal-to-noise-ratio and the efficiency in using the system resources can be considerably improved.

While the present invention has been described with respect to the particular embodiments, it will be apparent to those skilled in the art that various changes and modifications may be made without departing from the spirit and scope of the invention as defined in the following claims.

What is claimed is:

1. An apparatus, installed in an area where a pilot pollution phenomenon or soft blocking occurs, for relaying a signal transmitted from a specified base station to a mobile station, comprising:
a receiving means for receiving the signal transmitted from the specified base station;
a signal processing means for processing the received signal; and
a transmitting means for transmitting the processed signal to the mobile station.

2. The apparatus of claim 1, wherein the specified base station is a base station having relatively smaller number of calls than the other neighboring base stations.

3. The apparatus of claim 1, wherein the signal processing means includes:
a first filtering means for filtering only a signal within a service frequency band of the mobile phone from the received signal;
a first amplifying means for firstly amplifying the filtered signal;
a second amplifying means for secondly amplifying the firstly amplified signal;
an attenuating means for adjusting a gain of the secondly amplified signal so that the mobile station can respond to a surrounding system environment;
a third amplifying means for thirdly amplifying the gain-adjusted signal; and
a second filtering means for removing any noise from the thirdly amplified signal and providing the noise-removed signal to the transmitting means.

4. The apparatus of claim 1, wherein the receiving means is a high gain antenna with a narrow horizontal beam width.
